(19) United States
(12) Patent Application Publication
(10) Pub. No.: US 2008/0162246 A1
(43) Pub. Date: Jul. 3, 2008

(54) METHOD AND SYSTEM FOR CONTRACT BASED CALL CENTER AND/OR CONTACT CENTER MANAGEMENT

(75) Inventors: Ching-Hua Chen-Ritzo, Mahopac, NY (US); Daniel Connors, Pleasant Valley, NY (US); Laura Wynter, Chappaqua, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/619,564

(22) Filed: Jan. 3, 2007

(51) Int. Cl. G06Q 10/00

(52) U.S. Cl. 705/9; 705/8

(57) ABSTRACT

A method (and system) for allocating contacts to a vendor including determining an allocation of contacts to a vendor based upon one of a client to service provider payment structure, a service provider to vendor payment structure, and a client contact handling demand.

### BACKGROUND OF THE INVENTION

1. Field of the Invention

The present invention generally relates to a method and system for contact center management. In particular, the present invention relates to a method and system for contact center management in accordance with contact center performance.

2. Description of the Related Art

FIG. 1 illustrates a contact center environment 100. The environment 100 includes a client 102 that has a need for handling contacts. A client 102 may engage a service provider 104 and negotiate a contract with the service provider 104 to arrange to handle contacts for the client 102. In turn, the service provider 104 may outsource the handling of the contacts to one or a plurality of vendors 106. The service provider 104 may enter into a contract with the vendor to handle contacts on behalf of the service provider 104 for the client 102. Each vendor 106 may include one or more call centers 108 that actually handle the contacts.

Conventional contact center management systems may have the ability to perform tactical planning which determines the allocation of the contacts from the client among the vendors. Typically, such systems may focus upon the resources available at the various vendors to which the contacts may be allocated.

However, the conventional contact center management systems are not able to allocate the contacts based upon the terms in the contracts between the client 102 and the service provider 104 and the service provider 104 and the vendors 106.

### SUMMARY OF THE INVENTION

In view of the foregoing and other exemplary problems, drawbacks, and disadvantages of the conventional methods and structures, an exemplary feature of the present invention is to provide a method and system in which contacts are allocated among vendors in accordance with contract terms between clients and service providers and service providers and vendors.

In a first exemplary aspect of the present invention, a method for allocating contacts to a vendor includes determining an allocation of contacts to the vendor based upon one of a client to service provider payment structure, a service provider to vendor payment structure, and a client contact handling demand.

In a second exemplary aspect of the present invention a system for allocating contacts to a vendor includes a contact allocation determiner that determines an allocation of contacts to the vendor based upon one of a client to service provider payment structure, a service provider to vendor payment structure, and a client contact handling demand.

In a third exemplary aspect of the present invention a program embodied in a computer readable medium executable by a digital processing system for allocating contacts to a vendor includes instructions for determining an allocation of contacts to a vendor based upon one of a client to service provider payment structure, a service provider to vendor payment structure, and a client contact handling demand.

Conventional contact center management systems do not address the multiple-contract setting that is addressed by an exemplary embodiment of the present invention. Even in a non-outsourced setting, existing work in the area of contact center planning does not address the type of non-linear contracted cost structures that is addressed by an exemplary embodiment of the present invention. Therefore, an embodiment of the present invention has the advantage of leveraging information from all relevant contracts to provide more realistic decision support for contact center management.

An exemplary embodiment of the present invention relates generally to outsourcing contact center services, whereby voice calls, e-mails, faxes, voice and text messages and other types of communication are outsourced by one or more clients to one or more service providers. The service providers may in turn rely on contact centers run by one or multiple third-party vendors to actually handle the clients' contacts.

An exemplary embodiment of the present invention manages contact allocation based upon the contracts and, in particular, the cost structures of these contracts. For example, a cost structure may set varying rates for compensation for handling correspondingly varying call volumes. This embodiment allocates the contacts to vendors in accordance with this cost structure.

An exemplary embodiment of the present invention may allocate contacts to vendors based upon the skill sets and/or expertise as required by the client in the contract between the client and the service provider and the available skill sets and/or expertise provided by the vendors.

In an exemplary embodiment of the present invention, a client may provide information regarding the type of expected call volumes and the required skill types that would be required to handle those calls. This embodiment of the present invention would then determine the optimum allocation of those calls to various vendors. Further, the embodiment may then provide the vendors with a forecast of the volume of calls that they may expect to receive.

An exemplary embodiment of the present invention may provide vendors with support for making human resource decisions, such as, for example, hiring, firing, training, and the like over a planning horizon.

These and many other advantages may be achieved with the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary contact center management environment 100 in accordance with the present invention;

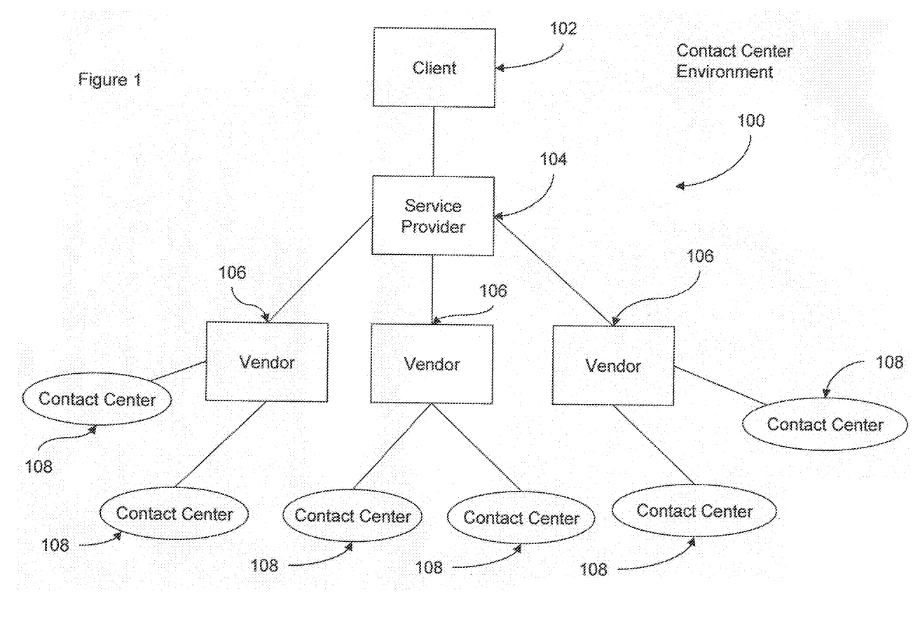

FIG. 2 illustrates an exemplary contact center management system 200 in accordance with the present invention;

FIG. 3 is a flowchart 300 of an exemplary contact management method in accordance with the present invention;

FIG. 4 illustrates a typical hardware configuration 400 which may be used for implementing the inventive system and method for managing contact centers; and

FIG. 5 illustrates exemplary signal bearing media for storing a program embodying an exemplary method for contact center management in accordance with the present invention.

### DETAILED DESCRIPTION OF EXEMPLARY EMBODIMENTS OF THE INVENTION

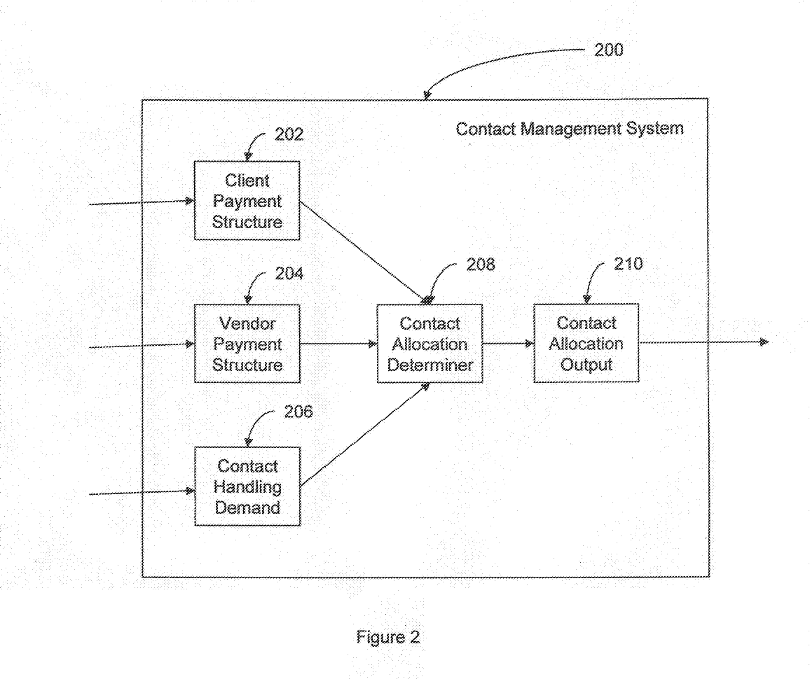

Referring now to the drawings, and more particularly to FIGS. 2-5, there are shown exemplary embodiments of the method and system of the present invention.

Tactical planning is an important part of contact center operations. Tactical planning horizons are generally several weeks to several months long, though they may also be as long as 18 months. Tactical planning for contact center management may involve the allocation of staff and other resource capacity, and to some extent an on-demand capability, to the forecasted demand for contact center services. In some cases, training of staff is possible within the tactical time frame. One exemplary embodiment of the present invention may perform tactical planning for contact center operations. Such an implementation of this system and method may also be referred to as a “tactical capacity planning tool.”

An exemplary embodiment of the present invention addresses tactical planning in an outsourced setting, where there may be one or more clients seeking contact center services from one or more service providers, and where the service provider(s) contracts the actual handling of contacts to one or more third-party vendors, who actually operate contact centers at various sites. In this setting, the contracts written between the various parties will determine the payments between parties. For example, a contract between a client and service provider will specify the payments, penalties and bonuses paid by the client to the service provider based on the call volume handled and quality of service. Meanwhile, a contract between a service provider and a third-party vendor will specify the payments that the service provider makes to the vendor based on the call volume handled and the utilization (or occupancy level) of the vendor's staff.

As an input, an exemplary embodiment of the present invention may accept a description of the resources that are available at the vendor sites over the planning horizon, including the skill types and availability of its staff, along with estimates of future demand and desired quality of service from the client(s). As an output, an exemplary embodiment of the present invention may provide specific recommendations regarding how to optimally allocate the clients' forecasted calls/contacts to the various vendor sites over the planning horizon. The recommended allocation of calls/contacts may be used to guide planning actions such as the setting of staffing levels at each vendor site, staff training schedules, and hiring and firing decisions, over the planning horizon. Due to its tactical nature, an exemplary embodiment of the present invention may be re-run every few weeks to a month.

While some conventional tools for tactical planning of contact centers exist, they do not consider the payment structures detailed by the contracts that exist between the client(s), the service provider(s) and the third-party vendor(s). Since contract terms and conditions define the payments between parties, consideration of the contract terms and conditions can significantly help to ensure the profitability of contact center operations.

For example, many contact center contracts are structured so that there is no benefit to exceeding a performance target. In this case, it should suffice to merely meet rather than exceed the performance target. This is particularly true towards the end of a billing period, when unnecessarily improving performance (e.g., profitability) typically comes at a price (e.g. routing to high-cost, high-performance sites or vendors). As another example, some contracts may impose discounts if call volumes exceed a certain threshold. In this case, it may be advantageous to ensure that these thresholds are exceeded, particularly when the discount is significant.

An exemplary embodiment of the present invention couples the tactical planning for contact centers tightly to the contract terms and conditions and the billing period, so as to optimize performance of the centers. Exemplary performance measures include, for example, profit, revenue, cost to the client(s), service provider(s) and/or vendors(s), overall service levels, and the like.

An exemplary embodiment of the present invention provides a method for solving the problem of optimizing contact center performance with respect to multiple simultaneous outsourcing contracts written between the service provider(s), the client(s) and the third-party vendor(s). This embodiment may be used to provide decision support for tactical planning for contact centers. Its solution may provide guidance to decision makers regarding how to allocate calls and how to staff vendor sites, over the planning horizon. Call allocation and staffing decisions are made at the tactical level (e.g., in monthly time buckets, or time buckets corresponding to the length of a billing cycle).

An exemplary embodiment of the present invention takes as input information regarding the contracts in place between the service provider(s) and the client(s), and between the service provider(s) and the third-party vendor(s), who carry out the actual contact center operations.

The information shared between a client and a service provider may include but is not limited to information on billing periods, prices, penalties, bonuses, constraints, and service quality metrics of interest to the client.

The information shared between a service provider and a vendor may include but is not limited to information regarding the price structures (cost per minute, volume discounts, occupancy-rate-dependent prices, etc) they charge, the availability of staff, staff productivity levels, the rates for hiring, firing and overtime, minimum or maximum occupancy (i.e., utilization) levels, maximum variability in occupancy levels from month to month, the skills of the existing staff in terms of the types of calls that they can handle, and the historical the quality of service that the staff have provided, on average, for various service quality metrics of interest.

Information on the expected incoming load may also be input into the invention. This expected load may be a forecast of the number of calls or contacts, by type, that is likely to arrive over certain intervals (e.g., the billing period) within the planning horizon.

An exemplary embodiment of the present invention takes the input data and may produce an optimal staff utilization plan, which allocates the forecasted load to the staff available at each vendor site, over the planning horizon. This staff utilization plan may dictate how calls or contacts should be directed across vendors for the next several billing cycles, and suggests a hiring, firing, training, and overtime schedule over that time frame.

An exemplary embodiment of the present invention may use a model to represent the various parameters and constraints involved in a tactical contact center planning problem for the outsourcing setting previously described. An objective function for the model may vary, depending on the objective of the user of the invention.

Examples of objectives may include, for example, maximizing revenue to a service provider, minimizing cost to a client, maximizing revenue to a vendor, minimizing variability in staff utilization levels (or occupancy levels) at the vendor sites over the planning horizon, and the like. The value of such an objective function may depend primarily on the allocation of the forecasted load across vendor sites. The model may be used to optimize a given objective function using mixed-integer optimization. In particular, solving the model may generate the allocation of the forecasted load across vendor sites that will optimize the given objective function. In addition, the solution generated by the optimized model may suggest how to manage the vendor's workforce with respect to hiring, firing, training, and overtime, by vendor, vendor site and skill type.

FIG. 2 illustrates one exemplary contact management system 200 in accordance with the present invention. The contact management system 200 receives a client payment structure 202 based upon a contract between the service provider 104 and the client 102. The contact management system 200 also receives a vendor payment structure 204 based upon a contract between the service provider 104 and the vendor(s) 106. The contact management system 200 also receives a contact handling demand 206 from the client 102. The contact handling demand 206 may include a forecast of the type and volume of contacts that require handling. The contact management system 200 may also include a contact allocation determiner 208 that determines the allocation of the contacts among the vendors 106. The contact management system 200 further includes a contact allocation output device 210 that outputs the contact allocation that is received from the contact allocation determiner 208.

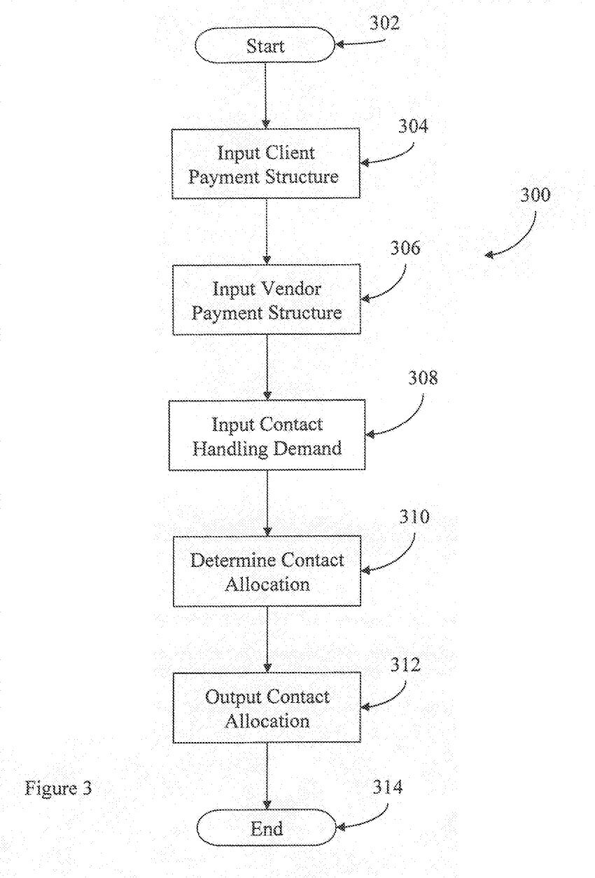

FIG. 3 is a flowchart 300 of one exemplary method in accordance with the present invention. The flowchart starts at step 302 and continues to step 304, where the contact management system 200 inputs the client payment schedule based upon the contract between the client 102 and the service provider 104. Next, the method inputs the vendor(s) payment structure in step 306 based upon the contact(s) between the service provider 104 and the vendor(s) 106. The method continues to step 308 where the method inputs the contact handling demand from the client 102 and continues to step 310.

In step 310, the method determines the contact allocation based upon the input client payment structure, the input vendor payment structure, and the input contact handling demand and continues to step 312. In step 312, the method outputs the determined contact allocation to a user and then ends in step 314.

The following description presents a hypothetical outsourcing situation where there is one client, one service provider and multiple contact center vendors. This formulation is a specific example of how an exemplary method in accordance with the present invention may be implemented.

The client may forecast the volume (for example, in minutes) of calls it expects to receive over a planning horizon (for example. the next 12 months). Call volume forecasts may be classified by “line of business” (LOB). In this example, the line of business is representative of the skills, or training, of a call center staff. In general, a line of business may be defined as either a specific skill or a specific collection or combination of skills. The client outsources the management of its calls to the service provider. The service provider does not directly handle the client's calls. Instead, it directs the client's calls to multiple contact center vendors. Each vendor may in turn manage centers located at multiple sites, and each vendor site may only be capable of handling calls belonging to a subset of all lines of business. Vendors also may have a limited capacity to handle calls at each site. Therefore, the service provider decides how to allocate or assign the client's forecasted call volume (on a month-to-month basis) to each vendor, subject to the aforementioned constraints on the vendors.

According to a contract, the client pays the service provider according to the volume of calls that is managed by the service provider. In particular, the client may pay a fixed rate per minute of calls managed. This rate may vary according to the vendor site that ultimately handles the call. There may also be service level agreements that the service provider has with the client. In particular, the client and service provider may agree on targeted performance using, for example, the following measures: Average Handling Time (AHT), First Call Resolution (FCR) and Customer Satisfaction (CSAT). For AHT and FCR, the client might pay a bonus to the service provider when the service provider outperforms the targeted levels. The bonus paid may be proportional to the degree to which the service provider outperforms the targeted levels. For all three metrics, when the targeted performance is not achieved, the service provider may pay a penalty to the client. For AHT and FCR, the penalty paid may be proportional to the degree to which the target is missed. For CSAT, however, the penalty paid may be proportional to the total revenue earned by service provider from the client (excluding bonuses).

The service provider may pay each vendor according to the volume of calls that the vendor handles. The payment to each vendor may depend not only on the total minutes of each LOB handled by the vendor, but also on the utilization, or occupancy level, of the vendor. The occupancy level at a call center (or vendor) may be defined as the ratio of the total volume of calls allocated to the call center (or vendor) and the total call volume capacity of the call center (or vendor).

The payments that the service provider pays to a vendor may possess, for example, one of two structures, depending on the type of vendor. The first type of vendor, referred to as a ‘regular’ vendor, may employ an all-units discounting scheme. Under this scheme, the rate that the vendor charges the service provider decreases with increasing call volume and occupancy level. That is, the vendor defines a rate for every combination of call volume and occupancy level. This rate may be constant within a certain range of values of call volume and occupancy level, and may decrease only after the call volume and occupancy levels exceed certain pre-determined threshold levels. There may exist several such threshold levels. The discounted rate may be applied to all calls at a given ‘regular’ vendor site. In general, different vendors may charge the service provider different rates.

The second type of vendor, may be referred to as a ‘thru’ vendor. A thru vendor may employ an incremental discounting scheme. Under this scheme, the rate that the vendor charges the service provider also decreases with increasing call volume handled and occupancy level at a given vendor site. However, a given discounted rate applies only to the portion of the call volume that lies in the range between the thresholds corresponding to the discounted rate. When determining the payment to a ‘thru’ vendor, call volumes may be aggregated across all sites belonging to the vendor.

Depending on who (i.e., the client, the service provider or a vendor) is utilizing the invention, the objective of the underlying optimization method may vary. Assuming that the invention is used by a service provider, then a reasonable objective may be to maximize the service provider's profit.

To formulate the hypothetical situation previously described, the following notation is defined:

Sets and Parameters:
P is the set of all LOBs
V_{R} is the set of regular Vendors
V_{T} is the set of all Vendors
S is the set of all Sites
S_{ν}⊂S is the subset of sites that belong to vendor νεV_{R}∪V_{T}
νₛ is the vendor of site νεS
T=Number of months in planning horizon
N_{ν}=Number of call volume threshold ranges for vendor νεV_{R}∪V_{T}
O_{ν}=Number of occupancy threshold ranges for vendor νεV_{R}∪V_{T}
cₛₚₜ=Capacity (in minutes) at site s for LOB p in month t,
where sεS, pεP, t=1, 2, . . . , T
dₚₜ=Call Volume Forecast (in minutes) for LOB p in month t, where pεP, t=1, 2, . . . , T

Client Service Level Related Contract Parameters:
AHTₛ=Historical average handling time (sec. per call) at site sεS
FCRₛ=Historical average fraction of calls handled within first response at site sεS
CSATₛ=Historical average customer satisfaction rating at site sεS
A H̅Tₜ=Targeting AHT in month t=1, 2, . . . , T
F C̅Rₜ=Targeted FCR in month t=1, 2, . . . , T
C S̅ATₜ=Targeted CSAT in month t=1, 2, . . . , T

### Vendor Cost Related Parameters:

f_{νno}=Rate (in dollars per minute) charged by vendor ν for in call volume threshold range n and occupancy threshold range o,
where n=1, 2, . . . , N_{ν} and o=1, 2, . . . , O_{ν}
b_{νno}=Amount that would be charged by vendor ν if the vendor's total call volume exactly fills threshold range n and occupancy threshold range o,
where n=1, 2, . . . , N_{ν} and o=1, 2, . . . , O_{ν}
LB_{νn}^{vol}=Lower limit on call volume in threshold range n=1, 2, . . . , N_{ν}
for vendor νεV_{R}∪V_{T}
UB_{νn}^{vol}=Upper limit on call volume in threshold range n=1, 2, . . . , N_{ν}
for vendor νεV_{R}∪V_{T}
LB_{νo}^{occ}=Lower limit on occupancy level in threshold range o=1, 2, . . . , O_{ν}
for vendor νεV_{R}∪V_{T}
UB_{νo}^{occ}=Upper limit on occupancy level in threshold range o=1, 2, . . . , O_{ν}
for vendor νεV_{R}∪V_{T}

The decisions that will influence the service provider's profit may be captured both directly and indirectly by the following variables:

### Decision Variables:

$${x}_{snopt} = Minutes of LOB p allocated to site s in month t at vendor cost rate {f}_{{υ}_{s} n 0} , \\ where p ∈ P , s ∈ S , t = 1 , … , T$$

$${y}_{snopt} = \{ \begin{matrix}1 , & \begin{matrix} if site s experiences call volume in \\ threshold range n and occupancy \\ in threshold range o in month t ,\end{matrix} \\ 0 , & otherwise ,\end{matrix} \\ for all s : {υ}_{s} ∈ {V}_{R} , n = 1 , 2 , … , {N}_{υ} , υ = 1 , 2 , … , {O}_{υ} , t = 1 , … , T \\ {\hat{y}}_{snopt} = \{ \begin{matrix}1 , & \begin{matrix} if vendor υ experiences call volume in threshold \\ range n and occupancy in threshold \\ range o in month t\end{matrix} \\ 0 , & otherwise ,\end{matrix} \\ for all υ ∈ {V}_{T} , n = 1 , 2 , … , {N}_{υ} , o = 1 , 2 , … , {O}_{υ} , t = 1 , … , T \\ {q}_{+ , t}^{AHT} ( {q}_{- , t}^{AHT} ) = Positive ( negative ) deviation of actual AHT from targeted AHT , t = 1 , … , T \\ {q}_{+ , t}^{FCR} ( {q}_{- , t}^{FCR} ) = Positive ( negative ) deviation of actual FCR from targeted FCR , \\ t = 1 , … , T \\ {q}_{+ , t}^{CSAT} ( {q}_{- , t}^{CSAT} ) = Positive ( negative ) deviation of actual CSAT from targeted CSAT , \\ t = 1 , … , T \\ {w}_{i} = \{ \begin{matrix}1 , & if CSAT target is met in month t \\ 0 , & otherwise .\end{matrix} \\ for all t = 1 , … , T \\ {z}_{t} = \{ \begin{matrix}{\sum }_{snopt} {r}_{s} {x}_{snopt} , & \begin{matrix} if CSAT target is not met in month t , \\ where t = 1 , … , T\end{matrix} \\ 0 , & otherwise .\end{matrix} \\ for all t = 1 , … , T \\ {λ}_{υ not} = \{ \begin{matrix}\begin{matrix} Fraction of interval [ {LB}_{υ n}^{vol} , {UB}_{υ n}^{vol} ] covered by \\ allocation of calls to vendor in month t ,\end{matrix} & if {\hat{y}}_{υ not} = 1 \\ 0 , & otherwise\end{matrix} \\ for all υ ∈ {V}_{T} , n = 1 , 2 , … , {N}_{υ} , o = 1 , 2 , … , {O}_{υ} , t = 1 , … , T$$

The primary decision variables are captured in xₛₙₒₚₜ, the allocation of calls from various LOBs to various vendors in each month. All other decision variables are auxiliary variables which are influenced by the value of xₛₙₒₚₜ.

The optimization model may be a formulation as a mixed-integer program as follows:

$$\begin{matrix}Objective Function & \\ \begin{matrix}max , Z = {\sum }_{snopt} {r}_{s} {x}_{snopt} \\ - {\sum }_{snopt : {υ}_{s} ∈ {V}_{R}} {f}_{{υ}_{s} n o} {x}_{snopt} \\ - {\sum }_{υ not : υ ∈ {V}_{T}} [ {\dot{y}}_{υ not} {b}_{υ no} + {λ}_{υ r ω t} ( {UB}_{υ n}^{vol} - {LB}_{υ n}^{vol} ) {f}_{υ no} ] \\ - {\sum }_{p t} {d}_{p t} ( {c}_{+}^{FCR} {q}_{+}^{FCR} - {c}_{-}^{FCR} {q}_{-}^{FCR} ) \\ - {\sum }_{p t} {d}_{p t} / A \overline{H} {T}_{t} ( {c}_{+}^{AHT} {q}_{-}^{AHT} - {c}_{-}^{AHT} {q}_{+}^{AHT} ) \\ - {\sum }_{t} {c}_{-}^{CSAT} {z}_{t}\end{matrix} & \begin{matrix}\begin{matrix}\begin{matrix}\begin{matrix}\begin{matrix}\begin{matrix}\begin{matrix}\begin{matrix}\begin{matrix}\begin{matrix}\begin{matrix}( 1 ) \\ \end{matrix} \\ ( 2 )\end{matrix} \\ \end{matrix} \\ ( 3 )\end{matrix} \\ \end{matrix} \\ ( 4 )\end{matrix} \\ \end{matrix} \\ ( 5 )\end{matrix} \\ \end{matrix} \\ \end{matrix} \\ ( 6 )\end{matrix}\end{matrix}$$

The service provider's objective may be expressed by the equation comprised of the terms (1)-(6). In the objective function, term (1) captures the revenue earned from the total volume of the client's calls that are managed by the service provider. Term (2) captures the payments that the service provider makes to regular vendors. Term (3) captures the payments that the service provider makes to ‘thru’ vendors. Term (4) captures the bonus (or penalty) earned (or paid) by the service provider for its performance with respect to the FCR target. Term (5) captures the bonus (or penalty) earned (or paid) by the service provider for its performance with respect to the AHT target. Term (6) captures the penalty paid by the service provider to the client if it fails to meet the CSAT target.

### Forecast Satisfaction Constraint

$${\sum }_{sno} {x}_{snopt} = {d}_{p t} ∀ p ∈ P , t = 1 , … , T \qquad ( 7 )$$

Equation (7) ensures that the forecasted call volume is satisfied by the service provider's allocation. In the case where vendor capacity is insufficient to handle the total forecasted call volume, a ‘dummy’ vendor with sufficiently large capacity and sufficiently high cost can be used to ‘handle’ all overflow calls. Any calls ‘handled’ by the dummy vendor in the solution to the model are unsatisfied in reality.

### Vendor Capacity Constraint

$${\sum }_{nop} {x}_{snopt} \leq {\sum }_{p} {c}_{spt} ∀ s ∈ S , t = 1 , … , T \qquad ( 8 )$$

Inequality (8) ensures that the service provider's allocation of calls to the vendors does not exceed the vendors' capacity to handle the allocated line of businesses. When a vendor site does not have any staff that possesses the skills to handle a particular line of business, then the site's capacity for that line of business is considered to be zero.

Inequality (8) may also be modified to accommodate hiring and firing decisions. For example, the summand in the right hand side of inequality (8) may be modified to include two additional terms: hₛₚₜ and gₛₚₜ, where hₛₚₜ is added to the existing capacity and represents the number of people hired at site s for line of business p in period t and gₛₚₜ is subtracted from the existing capacity and represents the number of people fired at site s for line of business p in period t. Additionally, the capacity term should reflect the capacity (i.e., number of employees) available at the end of the previous period. For example, the right hand side of inequality (8) could read

$${\sum }_{p} ( {c}_{spt - 1} + {h}_{spt} - {g}_{spt} ) .$$

Additional constraints may be required to ensure that the number of employees is ‘conserved’ from period to period. In this case, it means that the number of employees available at the end of a period t is equal to the number of employees available at the end of period t−1, plus any employees that were hired and minus any employees that were fired.

In order to account for the costs associated with employing, hiring and firing of staff, the objective function, given by (1) through (6) could be modified to include additional linear terms that capture these costs. Additional constraints may be used to bound the number of people hired or fired at each site for each line of business in each period. In particular, the number of people fired should be limited by the number of employees.

In a similar manner, the model may be modified to accommodate a training decision by introducing yet another set of variables that capture the decision to train employees who are currently able to perform in one line of business to perform in another line of business. Additional constraints may be required to ensure that there is a ‘conservation’ of employees from period to period. That is, all employees cannot simply ‘disappear’ or ‘appear’ unless they are accounted for through the training decisions. These constraints may also account for training time, which may span multiple periods. The cost of training may be captured in the objective function by including additional linear terms.

Inequality (8) may also be modified to allow employees which are trained in one line of business to service a demand for multiple lines of business, or to allow demands for different lines of business to be serviced by employees trained in the same line of business. These modifications may be relevant in the situation where employees trained to handle higher level tasks can also perform lower level tasks, or when lines of business are defined as a combination of skill sets.

### Occupancy-Based Vendor Rate ‘Selection’ Constraints

$$\begin{matrix}{\sum }_{p} {x}_{snopt} \leq {y}_{snot} {UB}_{{υ}_{s} o}^{occ} {\sum }_{p} {c}_{spt} ∀ s ∈ S , \\ n = 1 , … , {N}_{{υ}_{z}} , o = 1 , … , {O}_{{υ}_{s}} , t = 1 , … , T & ( 9 ) \\ {\sum }_{p} {x}_{snopt} \geq {y}_{snot} {LB}_{{υ}_{s} o}^{occ} {\sum }_{p} {c}_{spt} ∀ υ ∈ {V}_{T} , \\ n = 1 , … , {N}_{{υ}_{s}} , o = 1 , … , {O}_{{υ}_{s}} , t = 1 , … , T & ( 10 ) \\ {\sum }_{p s : s ∈ {S}_{o}} {x}_{snopt} \leq {y}_{υ not} {UB}_{υ o}^{occ} {\sum }_{p s : s ∈ {S}_{o}} {c}_{spt} ∀ υ ∈ {V}_{T} , \\ n = 1 , … , {N}_{υ} , o = 1 , … , {O}_{υ} , t = 1 , … , T & ( 11 ) \\ {\sum }_{p s : s ∈ {S}_{o}} {x}_{snopt} \geq {\hat{y}}_{υ not} {LB}_{υ o}^{occ} {\sum }_{p s : s ∈ {S}_{o}} {c}_{spt} ∀ υ ∈ {V}_{T} , \\ n = 1 , … , {N}_{υ} , o = 1 , … , {O}_{υ} , t = 1 , … , T & ( 12 )\end{matrix}$$

### Volume-Based Vendor Rate ‘Selection’ Constraints

$$\begin{matrix}{\sum }_{y} {x}_{snopt} \leq {y}_{snot} {UB}_{{υ}_{s} n}^{vol} ∀ s ∈ S , \\ n = 1 , … , {N}_{{υ}_{s}} , o = 1 , … , {O}_{{υ}_{s}} , t = 1 , … , T & ( 13 ) \\ {\sum }_{p} {x}_{snopt} \geq {y}_{snot} {LB}_{{υ}_{s} n}^{vol} ∀ s ∈ S , \\ n = 1 , … , {N}_{{υ}_{s}} , o = 1 , … , {O}_{{υ}_{s}} , t = 1 , … , T & ( 14 ) \\ {\sum }_{p s : n ∈ {S}_{c}} {x}_{snopt} \leq {\hat{y}}_{υ not} {UB}_{υn}^{vol} ∀ υ ∈ {V}_{T} , \\ n = 1 , … , {N}_{υ} , o = 1 , … , {O}_{υ} , t = 1 , … , T & ( 15 ) \\ {\sum }_{p s : n ∈ {S}_{c}} {x}_{snopt} \geq {\hat{y}}_{υ not} {LB}_{υn}^{vol} ∀ υ ∈ {V}_{T} , \\ n = 1 , … , {N}_{υ} , o = 1 , … , {O}_{υ} , t = 1 , … , T & ( 16 ) \\ {\sum }_{p s : n ∈ {S}_{c}} {x}_{snopt} = {\hat{y}}_{υ not} {LB}_{υn}^{vol} + {λ}_{υ not} ( {UB}_{υn}^{vol} - {LB}_{υn}^{vol} ) ∀ υ ∈ {V}_{T} , \\ n = 1 , … , {N}_{υ} , o = 1 , … , {O}_{υ} , t = 1 , … , T & ( 17 )\end{matrix}$$

Inequalities (9), (10), (13) and (14) jointly determine the qualifying discount rate for the occupancy level and call volume handled at each site belonging to a regular vendor. Inequalities (11), (12), (15) and (16) jointly determine the qualifying discount rate for the occupancy level and call volume handled at each site belonging to a ‘thru’ vendor. Equation (17) separates the call volume handled by a ‘thru’ vendor in terms of the number of discount ranges that it fully traverses, and the fraction of the discount range that it only partially traverses.

### Special Ordered Constraints

$$\begin{matrix}{\sum }_{no} {\hat{y}}_{snot} \leq 1 ∀ s \text{:} {υ}_{s} ∈ {V}_{R} , t = 1 , … , T & ( 18 ) \\ {\sum }_{no} {\hat{y}}_{υ not} \leq 1 ∀ υ ∈ {V}_{T} , t = 1 , … , T & ( 19 )\end{matrix}$$

Inequalities (18) and (19) ensure that, for each vendor, no more than one payment rate is applied in a given month.

### Service Level Agreement Constraints

$$\begin{matrix}( {\sum }_{snop} {x}_{snopt} {AHT}_{s} / {\sum }_{p} {d}_{p t} ) - A \overline{H} {T}_{t} = {q}_{+ , t}^{AHT} - {q}_{- , t}^{AHT} ∀ t = 1 , … , T & ( 20 ) \\ ( {\sum }_{snop} {x}_{snopt} {FCR}_{s} / {\sum }_{p} {d}_{p t} ) - F \overline{C} {R}_{t} = {q}_{+ , t}^{FCR} - {q}_{- , t}^{FCR} ∀ t = 1 , … , T & ( 21 ) \\ ( {\sum }_{snop} {x}_{snopt} {CSAT}_{s} / {\sum }_{p} {d}_{p t} ) - C \overline{S} {AT}_{t} = {q}_{+ , t}^{CSAT} - {q}_{- , t}^{CSAT} ∀ t = 1 , … , T & ( 22 )\end{matrix}$$

Equations (20), (21) and (22) determine the extent to which the AHT, FCR and CSAT performance, respectively, outperforms or misses its target.

### Linearizing Constraints

$$\begin{matrix}{q}_{- , t}^{CSAT} \leq {w}_{t}^{CSAT} ∀ t = 1 , … , T & ( 23 ) \\ {z}_{t} \leq {\overline{z}}_{t} {w}_{t}^{CSAT} ∀ t = 1 , … , T & ( 24 ) \\ {z}_{t} \geq {\sum }_{snop} {x}_{snopt} {r}_{s} - {\overline{z}}_{t} ( 1 - {w}_{t}^{CSAT} ) ∀ t = 1 , … , T & ( 25 )\end{matrix}$$

Inequalities (23), (24) and (25) are used to determine the penalty to be paid with respect to the CSAT service level metric. The penalty is greater than zero only if the CSAT target is missed. These linear inequalities are used to avoid expressions in the objective function which involve the multiplication of two or more decision variables with each other.

The solution to the optimization model will produce the values of xₛₙₒₚₜ that will result in the maximum profit for the service provider. If an alternative objective function is used (e.g., minimize client payments to service provider), then the values of xₛₙₒₚₜ produced by solving the modified optimization model will be the values that will optimize the new objective function.

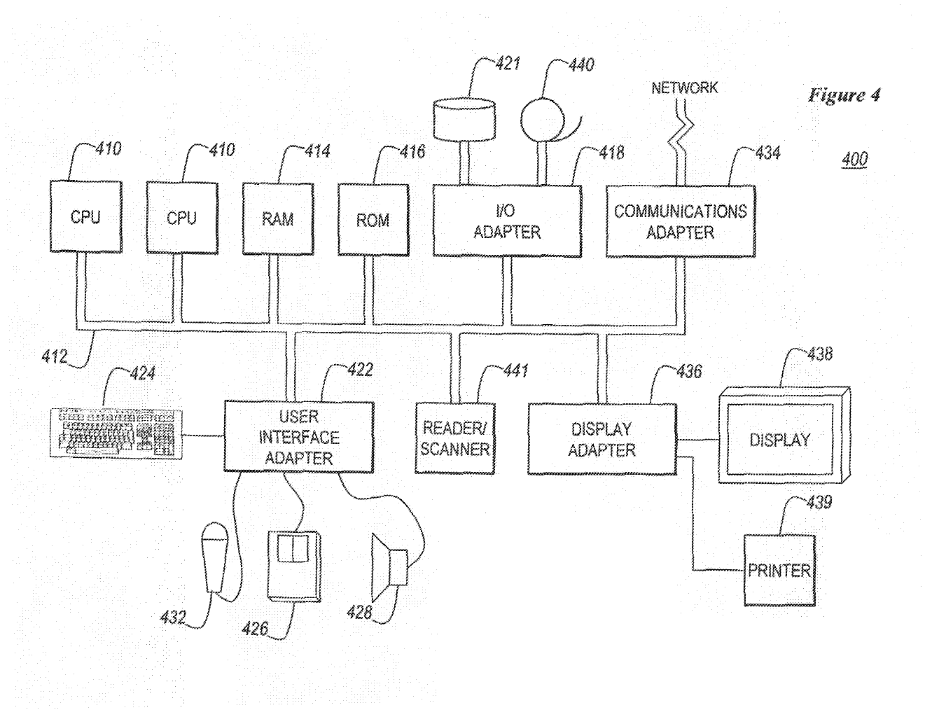

Referring now to FIG. 4, system 400 illustrates a typical hardware configuration which may be used for implementing the inventive system and method for managing contact centers. The configuration has preferably at least one processor or central processing unit (CPU) 410. The CPUs 402 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting an information handling system to a data processing network, the Internet, and Intranet, a personal area network (PAN), etc., and a display adapter 436 for connecting the bus 412 to a display device 438 and/or printer 439. Further, an automated reader/scanner 441 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 410 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 410 and hardware above, to perform the method of the invention.

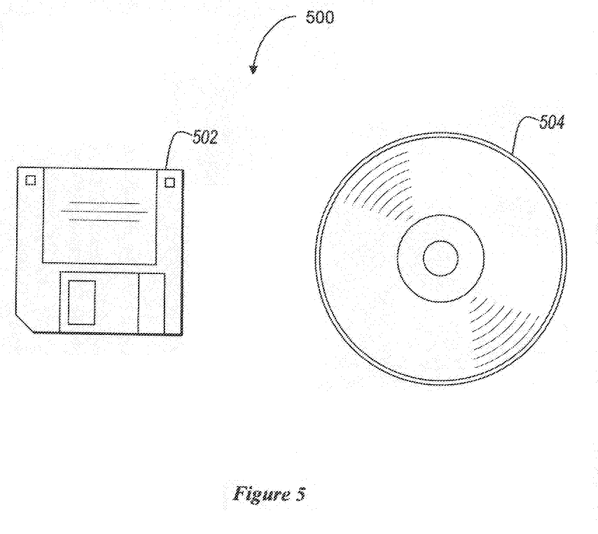

This signal-bearing media may include, for example, a RAM contained within the CPU 410, as represented by the fast-access storage for example. Alternatively, the instructions may be contained in another signal-bearing media, such as a magnetic data storage diskette 500 or CD-ROM 502, (FIG. 5), directly or indirectly accessible by the CPU 410.

Whether contained in the computer server/CPU 410, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media. In an illustrative embodiment of the invention, the machine-readable instructions may comprise software object code, complied from a language such as “C,” etc.

While the invention has been described in terms of several exemplary embodiments, those skilled in the art will recognize that the invention can be practiced with modification.

Further, it is noted that, Applicants' intent is to encompass equivalents of all claim elements, even if amended later during prosecution.

What is claimed is:

1. A method for allocating contacts to a vendor, comprising determining an allocation of contacts to said vendor based upon one of a client-to-service provider payment structure, a service provider-to-vendor payment structure, and a client contact handling demand.

2. The method of claim 1, further comprising:
receiving the client-to-service provider payment structure;
receiving the service provider-to-vendor payment structure; and
receiving the client contact handling demand.

3. The method of claim 1, wherein the determining of an allocation of contacts to a vendor comprises determining an allocation of contacts from a client among a plurality of vendors.

4. The method of claim 1, wherein the service provider-to-vendor payment structure comprises a plurality of payment structures to a plurality of vendors, and wherein the client-to-service provider payment structure comprises a plurality of payment structures from a plurality of clients to said service provider.

5. The method of claim 1, wherein one of the client-to-service provider payment structure and the service provider-to-vendor payment structure comprises a non-linear structure.

6. The method of claim 1, wherein said determining an allocation of contacts optimizes an objective function provided by a user.

7. The method of claim 6, wherein optimizing said objective function comprises one of minimizing a cost to said client, maximizing a profit to said service provider, maximizing revenue to said service provider, minimizing cost to said service provider, maximizing revenue to said vendor, and minimizing variability in staff utilization levels at said vendor.

8. The method of claim 1, further comprising determining an allocation of resources by said vendor based upon said determined allocation of contacts, wherein said allocation of resources comprises one of a staffing level adjustment, a hiring, a firing, and a training action.

9. The method of claim 1, further comprising receiving a description of the resources available at said vendor for handling contacts, wherein said determining of the allocation of contacts is based upon said description of the resources available at said vendor for handling contacts.

10. A system for allocating contacts to a vendor, comprising a contact allocation determiner that determines an allocation of contacts to said vendor based upon one of a client-to-service provider payment structure, a service provider to vendor payment structure, and a client contact handling demand.

11. The system of claim 10, further comprising:
a client payment structure storage in communication with said contact allocation determiner;
a vendor payment structure storage in communication with said contact allocation determiner; and
a contact handling demand storage in communication with said contact allocation determiner.

12. The system of claim 10, wherein said contact allocation determiner determines an allocation of contacts among a plurality of vendors.

13. The system of claim 10, wherein one of the client-to-service provider payment structure and the service provider-to-vendor payment structure comprises a non-linear structure.

14. The system of claim 10, wherein said contact allocation determiner optimizes an objective function provided by a user.

15. The system of claim 14, wherein optimizing said objective function comprises one of minimizing a cost to said client, maximizing a profit to said service provider, maximizing revenue to said service provider, minimizing cost to said service provider, maximizing revenue to said vendor, and minimizing variability in staff utilization levels at said vendor.

16. The system of claim 10, wherein said contact allocation determiner further determines the allocation of resources by said vendor based upon said determined allocation of contacts.

17. The system of claim 10, wherein said contact allocation determiner further determines the allocation of contacts based upon a description of the resources available at said vendor for handling contacts.

18. The system of claim 10, wherein said client contact handling demand comprises one of an expected volume of contacts, a required level of skill, a line of business, a required level of quality, a desired average handling time, a desired first call resolution, and a desired customer satisfaction level.

19. A program embodied in a computer readable medium executable by a digital processing system for allocating contacts to a vendor, said program comprising instructions for executing the method of claim 1.

20. A system for allocating contacts to a vendor comprising means for determining an allocation of contacts to said vendor based upon one of a client-to-service provider payment structure, a service provider-to-vendor payment structure, and a client contact handling demand.
